(19) United States
(12) Patent Application Publication
(10) Pub. No.: US 2008/0031391 A1
(43) Pub. Date: Feb. 7, 2008

(54) RECEIVING APPARATUS FOR RETRANSMISSION DIVERSITY

(75) Inventors: Jae HO ROH, Seoul (KR); Baozhi CHEN, New York, NY (US); Myung Jong LEE, New York, NY (US)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/833,742

(22) Filed: Aug. 3, 2007

Related U.S. Application Data
(60) Provisional application No. 60/835,109, filed on Aug. 3, 2006.

(30) Foreign Application Priority Data
Oct. 12, 2006 (KR) 10-2006-0099237

(51) Int. Cl. H04B 7/08

(52) U.S. Cl. 375/347

(57) ABSTRACT

A receiving apparatus for retransmission diversity includes: a sum module generating a second signal by summing up a first signal and at least one retransmitted signal of the first signal, when a first packet determined by the first signal received from a transmitter is incorrect; and a controller requesting the transmitter to retransmit the first signal when a second packet, which has been determined from the second signal, is incorrect.

### CROSS-REFERENCE TO RELATED APPLICATION

This application claims priority from U.S. Provisional Application No. 60/835,109, filed on Aug. 3, 2006, in the U.S. Patent and Trademark Office, and from Korean Patent Application No. 10-2006-0099237, filed on Oct. 12, 2006, in the Korean Intellectual Property Office, the disclosures of both of which are hereby incorporated by reference in their entirety.

### BACKGROUND OF THE INVENTION

1. Field of the Invention

Apparatuses and methods consistent with the present invention relate to wireless communication. More particularly, the present invention relates to a receiving apparatus capable of effectively embodying retransmission diversity.

2. Description of Related Art

In a wireless communication environment that uses a wireless radio wave, a multi-path phenomenon occurs due to topographical aspects affecting a radio wave path, such as buildings, which causes a fading phenomenon, that is, an amplitude of a received signal changes. A diversity method is provided in order to prevent a degradation of transmission quality due to the fading phenomenon. The diversity method is a signal processing method which compares a plurality of received signals with a processed signal, which is singularly transmitted, by using an appropriate synthesis of the plurality of the received signals transmitted via at least two independent radio wave paths in order to have a favorable feature. There are various methods for the diversity method, such as space diversity, polarization diversity, time diversity, frequency diversity and retransmission diversity.

FIG. 1 is a diagram illustrating a retransmission scheme according to a conventional art. The following assumes that an error in a packet 101 transmitted from a transmitter during transmission operation occurred due to the fading phenomenon. A receiver detects the error of the packet 101, and requests the transmitter for a retransmission by transmitting a negative acknowledgement (NAK) packet 102 to the transmitter. The transmitter transmits a packet 103 which is a retransmission of packet 101. The receiver requests the transmitter for a retransmission by again transmitting an NAK packet 104 to the transmitter when the packet 103 is incorrect. Also, the transmitter again retransmits a packet 105, which is identical to the packet 101. When the above retransmission requests are repeated for some amount of time and the packet 105 is finally correctly received, the receiver transmits an ACK packet 106 to the transmitter. Subsequently, the transmitter transmits a new packet 107 to the receiver.

In the conventional art, a packet or a signal, which are already received and determined to have an error, are not used to identify a single packet. Namely, useful information included in packets which are determined to contain error is just dropped.

Therefore, a receiving apparatus for retransmission diversity which can readily detect a currently received packet by using useful information of previous packets determined to have errors, is needed.

### SUMMARY OF THE INVENTION

An exemplary embodiment of the present invention provides a receiving apparatus for retransmission diversity which can readily detect a currently received packet, which are incorrectly received, by using useful information of previous packets.

The present invention also provides a receiving apparatus for retransmission diversity which can reduce a number of retransmission using a packet or a signal, which have been received with an error in the previous transmission, with respect to a single packet, in a communication system such as a code division multiple access (CDMA).

According to an aspect of the present invention, there is provided a receiving apparatus for retransmission diversity including: a sum module generating a second signal by summing up a first signal and at least one retransmitted signal of the first signal, when a first packet determined by the first signal received from a transmitter is incorrect; and a controller requesting the transmitter to retransmit the first signal when a second packet, which has been determined from the second signal, is incorrect.

In this case, the receiving apparatus further includes a second decision module determining the second packet from the second signal and a second error checker checking whether the second packet is correct.

According to another aspect of the present invention, there is provided a receiving apparatus for retransmission diversity including: a sum module generating a second packet by summing up a first packet and at least one retransmission packet of the first packet, when the first packet determined by a first signal received from a transmitter is incorrect; and a controller requesting the transmitter to retransmit the first signal when a second packet is incorrect.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating for a retransmission scheme according to a conventional art;

FIG. 2 is a diagram illustrating a retransmission diversity method according to an exemplary embodiment of the present invention;

FIG. 3 is a block diagram illustrating a receiving apparatus according to an exemplary embodiment of the present invention;

FIG. 4 is a flowchart illustrating operation of the receiving apparatus of FIG. 3;

FIG. 5 is a block diagram illustrating a receiving apparatus according to another exemplary embodiment of the present invention; and

FIG. 6 is a flowchart illustrating operation of the receiving apparatus of FIG. 5.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

FIG. 2 is a diagram illustrating a retransmission diversity method according to an exemplary embodiment of the present invention.

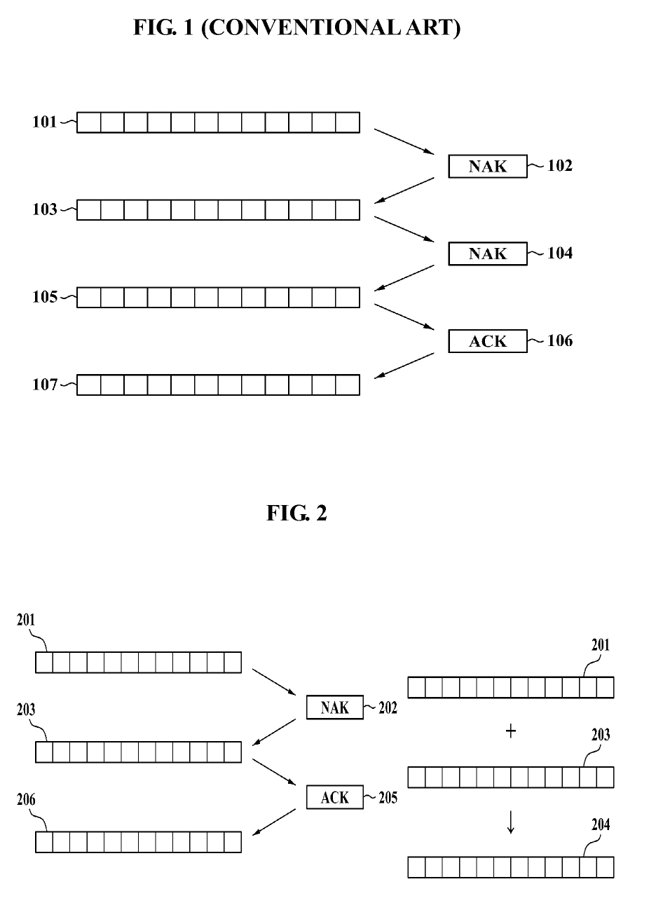

As in FIG. 1, there is an assumption that an error in a packet 201 occurred during a transmission operation due to the fading phenomenon. A receiver detects the error in the packet 201, and requests the transmitter for a retransmission by transmitting the NAK packet 202 to the transmitter. The transmitter transmits a packet 203 which is a retransmission of packet 201. In the conventional art, the retransmission is requested by transmitting the NAK packet to the transmitter again, when the packet 203 is incorrect. However, in the present invention, a packet 204 is generated by summing up the currently received packet 203 and the retransmission packet 201, and the summed packet 204 is checked to determine if errors are present. When the error is not detected, the receiver uses the summed packet 204 without requesting the retransmission. The receiver transmits an ACK packet 205 to the transmitter, and the transmitter transmits a new packet 206 to the receiver. The receiver is required to request the transmitter for a retransmission when an error is found in the summed packet 204, i.e., when the summed packet 204 is not determined to be the correct packet. For summing up of the two packets, a bit by bit digital addition may be used. Since each of the two packets is a digital string, the two digital strings are added. In this case, a conventional adder can be used. It is also clear to those skilled in the art that other methods of digitally summing up of two packets can be used for the present invention.

For the previous packets detected as having errors, all information of the previous packets is not useless, but only some information of the previous packets are useless. Accordingly, more packets may be correctly detected according to the present invention since the packet is detected by summing up a plurality of packets, which are retransmitted for a single packet.

Retransmission packets indicate packets determined, in a receiver, as having an error, that were transmitted before the currently received packet, even though the identical signal was transmitted from a transmitter for the retransmission packets and the currently received packet. Also, retransmitted signals indicate signals determined, in the receiver, as having an error, that were transmitted before the currently received signal, even though the identical signal was transmitted for the retransmission signals and the currently received signal.

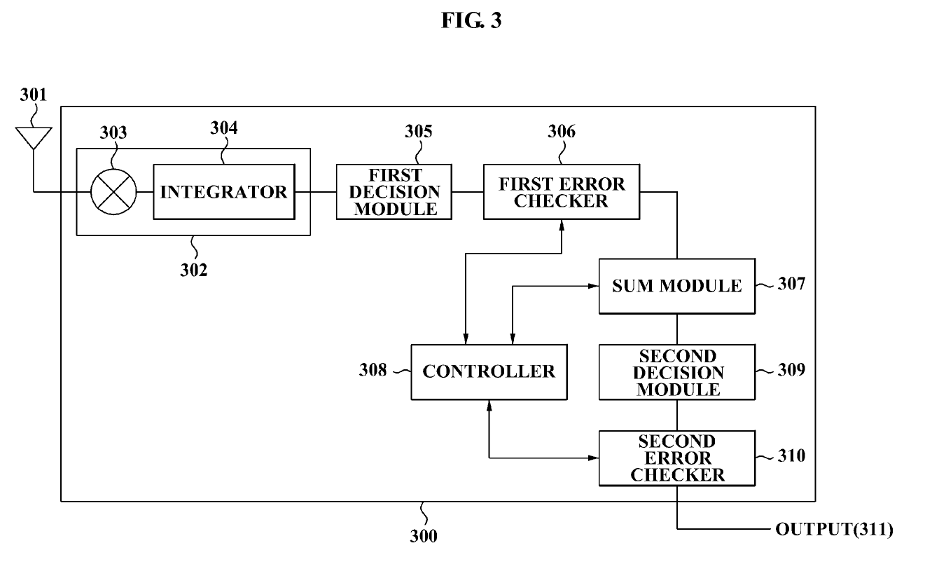

FIG. 3 is a block diagram illustrating a receiving apparatus according to an exemplary embodiment of the present invention.

A receiver 300 includes a matched filter 302, a first decision module 305, a first error checker 306, a sum module 307, a controller 308, a second decision module 309, and a second error checker 310.

The matched filter 302 detects a first signal by despreading a wireless signal received via an antenna 301. A transmitter multiplies an individual code of each receiver by a transmission signal in a CDMA system, and transmits the result of the multiplication. Accordingly, the wireless signal received via the antenna 301 may include all signals with respect to all the receivers. The matched filter 302 detects its own signal of a receiver by multiplying an individual code of the receiver by the entire signal. The matched filter 302 includes a multiplier 303 and an integrator 304.

The first decision module 305 generates a first packet according to a first signal from the matched filter 302. Namely, the first decision module 305 generates the first packet in a digital form, which is configured in a combination of ‘0’ and ‘1’ according to the first signal. There are a hard decision and a soft decision as methods of the generation, and depending upon the embodiment of the present invention, the hard decision may be used for the generation in the first decision module 305. Also, the second decision module 309 generates a packet in a digital form from a signal added by the sum module 307. The first decision module 305 and second decision module 309 may be embodied as a separated hardware module or a software module, or may be embodied by sharing an identical hardware or a software module.

The first error checker 306 checks whether the first packet is correct. Namely, the first error checker 306 checks whether there is an error in the first packet. A simple cyclic redundancy checking (CRC) may be used for checking the packet error in the first error checker 306. The first error checker 306 and the second error checker 310 may be embodied as a separated hardware module or a software module, or may be embodied by sharing an identical hardware or a software module.

The sum module 307 generates a summed signal by summing (1) a retransmitted signal of a signal detected by the matching filter 302 and (2) the signal.

According to the embodiment of the present invention, the sum module 307 may generate the summed signal by summing up amplitudes of a plurality of inputted signals. The retransmitted signal is a signal which is determined, in the receiver, as having an error even though the identical signal was transmitted for the retransmission signal and the currently received signal detected by the matching filter 302. Specifically, when a currently received signal is a signal of the packet 203 of FIG. 2, a signal of the packet 201 of FIG. 2 corresponds to the retransmitted signal. The packet 201 of FIG. 2 includes the error that has been detected, and the transmitter has retransmitted the identical packet 203, therefore the signal of the packet 201 corresponds to the retransmitted signal.

The controller 308 controls the sum module 307 as a result of the first error checker 306 and the second error checker 310, and transmits an ACK packet or a NAK packet to the transmitter. Specifically, when the packet generated by the first decision module 305 is determined as correct as the result of the checking of the first error checker 306, the controller 308 transmits the ACK packet to the transmitter. Also, when the packet generated by the second decision module 309 is determined as correct as the result of the checking of the second error checker 310, the controller 308 transmits the ACK packet to the transmitter.

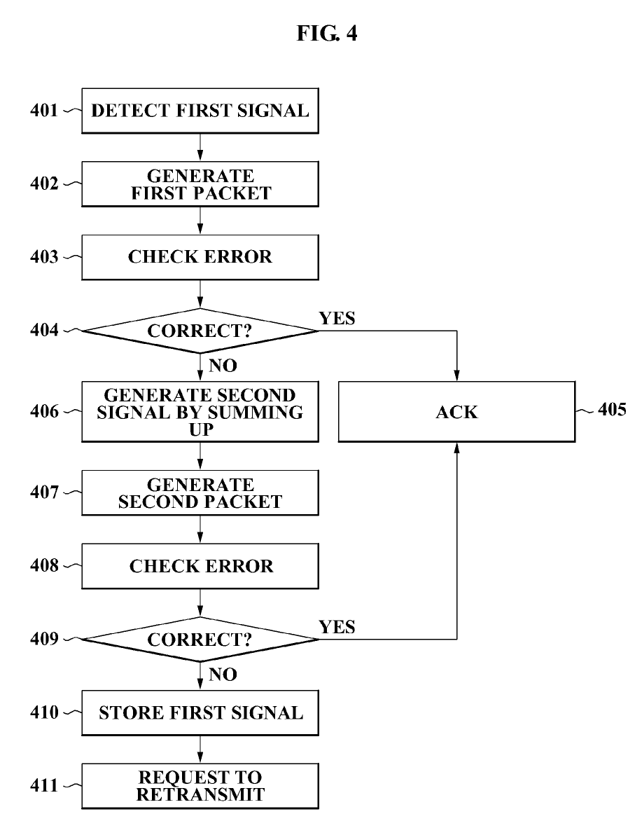

Hereinafter, operations of the receiving apparatus illustrated in FIG. 3 will be described in detail by referring to FIG. 4.

In operation 401, the matched filter 302 of FIG. 3 detects a first signal by dispreading a received wireless signal via the antenna of FIG. 3.

In operation 402, the first decision module 305 of FIG. 3 generates a first packet from the first signal detected at the matched filter 302. The first decision module 305 of FIG. 3 generates the first packet in digital form, which is configured in a combination of ‘0’ and ‘1’, according to the first signal. Depending upon the embodiment of the present invention, a hard decision is used for the first decision module 305.

In operations 403 and 404, the first error checker 306 of FIG. 3 checks whether the first packet is correct. Specifically, the first error checker 306 checks whether there is an error in the first packet. A CRC may be used for the checking of the error in the first error checker 306 of FIG. 3.

As the result of the checking of the first error checker 306 in operations 403 and 404, when the first packet is correct, the controller 308 transmits an ACK packet to the transmitter in operation 405.

As the result of the checking of the first error checker 306 in operations 403 and 404, the sum module 307 of FIG. 3 generates a second signal by summing up the first signal and at least one retransmitted signal of the first signal in operation 406. The retransmitted signal is a signal which is determined, in the receiver, as having an error even though the retransmitted signal and the first signal were transmitted from the transmitter with the identical signal. The retransmitted signals are stored in a predetermined storage unit such as RAM, ROM, a flash memory, an EPROM, an EEPROM, and the like.

In operation 407, the second decision module 309 of FIG. 3 generates a second packet from a second signal.

As an example, it is assumed that packets 201, 203, 204 and 206 of FIG. 2 are signals. The signal 201 of FIG. 2 is stored in the predetermined storage unit when a packet generated from the signal 201 is received with an error. A stored retransmitted signal of the signal 201 does not exist yet when the signal 201 is received. In this instance, the controller 308 of FIG. 3 requests the transmitter to retransmit the signal 201, and stores the signal 201 in the predetermined storage unit.

The transmitter retransmits the signal 203 of FIG. 2, which is identical to the signal 201. The present invention again generates a packet from the signal 203 using the stored retransmitted signal 201 when the packet determined from the signal 203 is incorrectly received. Namely, the sum module 307 of FIG. 3 sums up the signals 201 and 203, and the second decision module 309 of FIG. 3 again generates the packet. Although each of the two signals 201 and 203 are received with errors, an accuracy of a newly determined packet increases by summing up the two signals 201 and 203. Thus, there is no need to request the transmitter for a retransmission when the newly generated packet is correct.

The sum module 307 may generate a second signal by summing up all of the retransmitted signals of the first signal and the first signal. When the receiver receives ‘n’ pieces of signals A₁, A₂, A₃, . . . , Aₙ with respect to a signal A, and when the signal Aₙ is incorrect, the second signal is generated by summing up the signals A₁, A₂, A₃, . . . , Aₙ in order to determine a packet of the signal A, and the packet is determined from the second signal. Also, according to another embodiment of the present invention, the packet is determined by summing up some of the retransmitted signals of the signal A₁, A₂, A₃, . . . , Aₙ₋₁ and the current signal Aₙ, instead of summing up all of the retransmitted signals of the signal A₁, A₂, A₃, . . . , Aₙ₋₁, and the current signal Aₙ.

In operation 407, the second error checker 310 of FIG. 3 checks whether the second packet is correctly received. A CRC may be used for the checking of the error in the second error checker 310.

As the result of the checking of the second error checker 310 in operations 408 and 409, when the second packet is correctly received, the controller 308 of FIG. 3 transmits an ACK packet to the transmitter in operation 405. The second packet, which is determined as having no error, is transmitted to an output 311.

As the result of the checking of the second error checker 310 in operations 408 and 409, when the second packet contains errors, the controller 308 stores a first signal in the predetermined storage unit in operation 410, and requests the transmitter to retransmit the first signal in operations 411. The first signal is used to determine whether a subsequent signal is to be retransmitted from the transmitter. The controller 308 may request the transmitter to retransmit the first signal by transmitting a NAK packet to the transmitter.

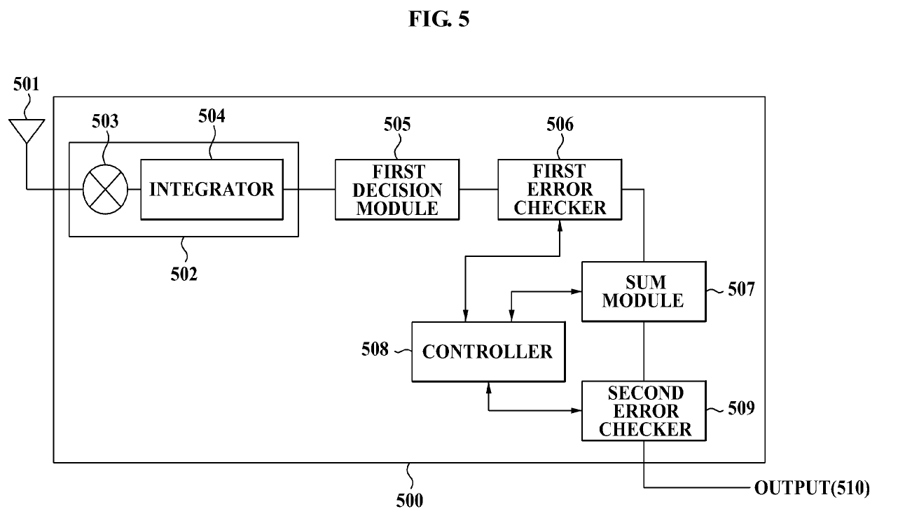

FIG. 5 is a block diagram illustrating a receiving apparatus according to another exemplary embodiment of the present invention.

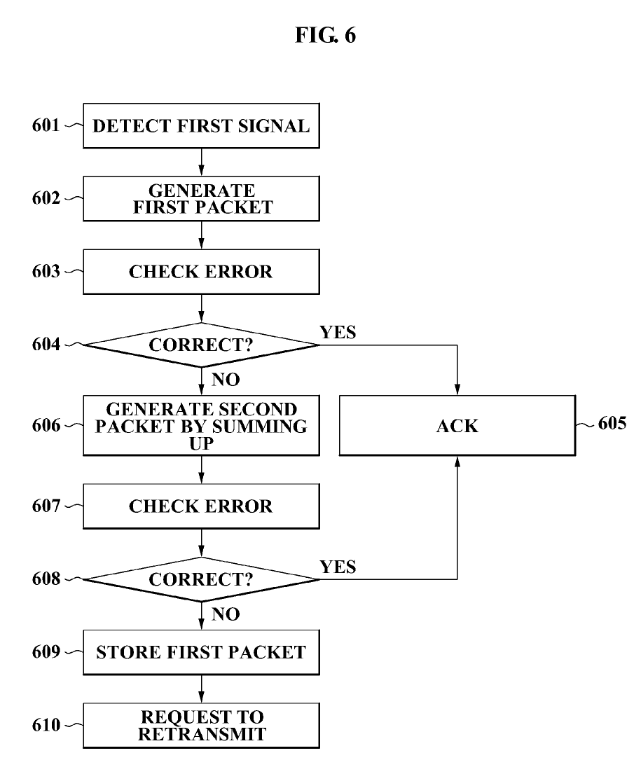

In the embodiments as described with FIGS. 3 and 4, a probability of determining a correct packet is increased by using the retransmitted signals determined as having errors, in the receiver, that were transmitted before the currently received signal. The identical signal, however, was transmitted for the retransmission signals and the currently received signal. Moreover, in the embodiments as described with FIGS. 5 and 6, an accuracy of determining a correct packet is also increased by using a retransmission packet, which is determined as a packet having an error in the receiver, and transmitted before the currently received packet. The identical packet, however, was transmitted for the retransmission packets and the currently received packet.

A receiver 500 includes a matched filter 502, a first decision module 505, a first error checker 506, a sum module 507, a controller 508, and a second error checker 509.

Descriptions regarding an antenna 501, the matched filter 502, an integrator 504, the first decision module 505, and the first error checker 506 will be omitted in this specification since the descriptions are same as the descriptions regarding the antenna 301, the matched filter 302, the multiplier 303, the integrator 304, the first decision module 305, and the first error checker 306 of FIG. 3. Hereinafter, operations of the sum module 507, the controller 508, and the second error checker 509 will be described in detail by referring to FIG. 6.

FIG. 6 is a flowchart illustrating operations of the receiving apparatus illustrated in FIG. 5.

Before describing of operations of the sum module 507, the controller 508, and the second error checker 509 of FIG. 5, operations 601 through 604 by the matched filter 502, the first decision module 505 and the first error checker 506 of FIG. 5 will be described in brief.

In operation 601, the matched filter 502 of FIG. 5 detects a first signal by despreading a received wireless signal via the antenna 501 of FIG. 5. The first decision module 505 of FIG. 5 determines a first packet from the first signal detected from the matched filter 502 in operation 602. According to the embodiment of the present invention, a hard decision is used in the first decision module 505. In operations 603 and 604, the first error checker 506 of FIG. 5 checks whether the first packet is correctly received. Namely, the first error checker 506 checks whether there is an error in the received first packet. A CRC may be used for the checking of the error in the first error checker 506.

Hereinafter, operations 605 through 610 will be described in detail with reference to the sum module 507, the controller 508, and the second error checker 509 of FIG. 5.

As the result of the checking of the first error checker 506 in operations 603 and 604, when the first packet is correct, the controller 508 transmits an ACK packet to a transmitter in operation 605.

As the result of the checking of the first error checker 506 of FIG. 5 in operations 603 and 604, when the first packet is received with an error, the sum module 507 generates a second packet by summing up the first packet and at least one retransmission packet of the first packet in operation 606.

A retransmission packet indicates a packet determined, in a receiver, as a packet having an error, that was transmitted before the currently received packet, even though the identical packet was transmitted from a transmitter for the retransmission packet and the currently received packet. As an example, when the receiver receives ‘n’ pieces of packets A₁, A₂, A₃, . . . , Aₙ with respect to a packet A, the packet Aₙ becomes a current packet and packets A₁, A₂, A₃, . . . , Aₙ₋₁ becomes retransmission packets of the packet Aₙ. According to the exemplary embodiment of the present invention, the sum module 507 generates the second packet by summing up all of the retransmission packets A₁, A₂, A₃, . . . , Aₙ₋₁, of the current packet Aₙ and the current packet Aₙ. Also, according to another embodiment of the present invention, the second packet is generated by summing up some of the retransmission packets A₁, A₂, A₃, . . . , Aₙ₋₁ and the current packet Aₙ, as opposed to summing up all of the retransmission packets A₁, A₂, A₃, . . . , Aₙ₋₁ of the current packet Aₙ and the current packet Aₙ.

The retransmission packets are stored in a predetermined storage unit such as a random access memory (RAM), a read only memory (ROM), a flash memory, an erasable programmable read only memory (EPROM), an electrically erasable and programmable read only memory (EEPROM), and the like. As an example, when the packet A₁ is received, and when the packet A₁ is incorrectly received, the controller 508 stores the packet A₁ in the predetermined storage unit. Next, when the packet A₂ is received, and when the packet A₂ is incorrectly received, the controller 508 generates the second packet and checks for an error, by summing up the stored packet A₁ and the packet A₂. Next, when the packet A₃ is received, and when the packet A₃ is incorrectly received, the controller 508 generates another second packet and checks the error, by summing up the stored packets A₁ and A₂ and the packet A₃. When the generated other second packet is correct, the receiver uses the other second packet without requesting the transmitter for a retransmission. However, when the generated other second packet is incorrect, the packet A₃ is stored in the predetermined storage unit.

The sum module 307 of FIG. 3 sums up signals in an analog form, the sum module 507 sums up packets in a digital form. According to the exemplary embodiment of the present invention, the sum module 507 synthesizes bits in which error is not detected from a bit stream configuring each packet. As an example, when the packet A₁ has errors in i^{th} and j^{th} bits, and when the packet A₂ has an error in a k^{th} bit, the sum module 507 synthesizes bit streams except for the i^{th} and j^{th} bits of the packet A₁ with i^{th} and j^{th} bits of the packet A₂.

In operation 607, the second error checker 509 checks whether the second packet, generated by the sum module 507, is correct. A CRC may be used for the checking of the error in the second error checker 509.

As the result of the checking of the second error checker 509 in operations 607 and 608, when the second packet is correct, the controller 508 transmits an ACK packet to the transmitter in operation 605. The second packet, determined as having no error, is transmitted to an output 510.

As the result of the checking of the second error checker 509 in operations 607 and 608, when the second packet includes errors, the controller 508 stores the first packet in the predetermined storage unit in operation 609, and requests the transmitter to retransmit the first packet in operation 610. The first packet is used for determining a subsequent packet to be retransmitted. The controller 508 may request the transmitter to retransmit the first packet by transmitting a NAK packet.

In the conventional art, useful information in incorrectly detected packets is wasted. Conversely, in the present invention, a currently received packet may be readily detected by using useful information of previous, incorrectly received packets. More packets may be correctly detected using packets or signals, which are already received with an error, with respect to a single packet.

According to the present invention, more packets may be correctly detected using packets or signals, which have been already received with errors, with respect to a single packet, the packet being wasted in the conventional art since the packet is determined as an incorrectly received packet. Thus, according to the present invention, a number of retransmission, which is caused by a fading phenomenon, may be reduced.

Although a few exemplary embodiments of the present invention have been shown and described, the present invention is not limited to the described exemplary embodiment. Instead, it would be appreciated by those skilled in the art that changes may be made to these exemplary embodiments without departing from the principles and spirit of the invention, the scope of which is defined by the claims and their equivalents.

What is claimed is:

1. A receiving apparatus for retransmission diversity, the apparatus comprising:
a sum module which sums up a first signal and at least one retransmitted signal of the first signal to generate a second signal, if a first packet generated from the first signal received from a transmitter, includes a first error; and
a controller which requests the transmitter to retransmit the first signal if a second packet generated from the second signal, includes a second error.

2. The receiving apparatus of claim 1, wherein the controller stores the first signal if the second packet includes the second error.

3. The receiving apparatus of claim 1, further comprising:
a second decision module which generates the second packet from the second signal.

4. The receiving apparatus of claim 1, further comprising:
a second error checker which checks whether the second packet includes the second error.

5. The receiving apparatus of claim 1, where the controller transmits an acknowledgement (ACK) packet to the transmitter if the second packet does not include any error.

6. The receiving apparatus of claim 1, wherein the sum module sums up all of the retransmitted signals of the first signal and the first signal to generate the second signal.

7. The receiving apparatus of claim 1, wherein the controller requests the transmitter to retransmit the first signal if a stored retransmitted signal of the first signal is non-existent, and stores the first signal.

8. The receiving apparatus of claim 1, further comprising:
a matching filter which detects the first signal by despreading a wireless signal received via an antenna.

9. The receiving apparatus of claim 1, further comprising:
a first decision module which generates the first packet from the first signal.

10. The receiving apparatus of claim 1, further comprising:
a first error checker which checks whether the first packet includes the first error.

11. The receiving apparatus of claim 1, wherein the controller transmits an acknowledgement (ACK) packet to the transmitter if the first packet does not include any error.

12. A receiving apparatus for retransmission diversity, the apparatus comprising:
a sum module which sums up a first packet and at least one retransmission packet of the first packet to generate a second packet, if the first packet generated from a first signal received from a transmitter, includes a first error; and
a controller which requests the transmitter to retransmit the first signal if a second packet includes a second error.

13. The receiving apparatus of claim 12, wherein the controller stores the first packet if the second packet includes the second error.

14. The receiving apparatus of claim 12, further comprising:
a second error checker which checks whether the second packet includes the second error.

15. The receiving apparatus of claim 12, wherein the controller transmits an acknowledgement (ACK) packet to the transmitter if the second packet includes the second error.

16. The receiving apparatus of claim 12, wherein the sum module sums up all of the retransmitted signals of the first signal and the first signal to generate the second signal.

17. The receiving apparatus of claim 12, wherein the controller, requests the transmitter to retransmit the first signal if a stored retransmission packet of the first packet is non-existent, and stores the first packet.
